(19) United States
(12) Patent Application Publication
(10) Pub. No.: US 2007/0207284 A1
(43) Pub. Date: Sep. 6, 2007

(54) Barrier article and method

(76) Inventor: Shawn A. McClintic, Glenville, NY (US)

Correspondence Address: SHAWN A. MCCLINTIC, GE GLOBAL RESEARCH, 34 SAINT STEPHENS LANE EAST, GLENVILLE, NY, 12302, US

(21) Appl. No.: 11/366,253

(22) Filed: Mar. 2, 2006

(51) Int. Cl. B32B 33/00; B32B 3/06

(52) U.S. Cl. 428/40.1; 428/99; 428/100; 428/354

(57) ABSTRACT

A barrier article and a method of making and using the barrier article are provided. The barrier article includes a base layer; an adhesive layer supported on a first surface of the support layer; and a barrier layer supported on a second surface of the support layer, opposite the adhesive layer.

### CROSS REFERENCE TO RELATED APPLICATIONS

This application is a non-provisional application claiming priority to provisional U.S. patent application Ser. No. ______, filed ______, and hereby incorporates by reference and claims benefit thereto.

### BACKGROUND

1. Technical Field

The invention includes embodiments that relate to a barrier article. The invention includes embodiments that relate to method of making and/or using a barrier article.

2. Discussion of Related Art

Barbed wire and barbed metal tape have been used as barriers to prevent or reduce access to defined areas. The barbed wire and barbed metal tape may be wound and unwound so that, when deployed, a substantially linear, spiral and/or helical barrier may be formed. Deployed wires and tapes sometimes may be fixed in place using, for example, pegs and fasteners.

It would be desirable to have a barrier article having improved properties, such as, for example, differing fastening mechanisms, differing deployment methods, differing manufacturing processes, differing modes of function, and the like. It would be desirable to have differing methods for making and using the same.

### SUMMARY

The invention has embodiments that relate to a barrier article that may include one or more of barrier properties, intrusion detection properties, and deterrent properties.

The invention has embodiments that relate to a barrier system. The invention has embodiments that relate to an intrusion detection system. The invention has embodiments that relate to a personal deterrent system.

In one embodiment, a barrier article may include a base layer; an adhesive layer supported on a first surface of the support layer; and a barrier layer supported on a second surface of the support layer, opposite the adhesive layer.

In one embodiment, a method may include securing a plurality of barrier structures to a base layer, each of the barrier structures having an extended end spaced from the base layer; and may further include securing an adhesive layer to a surface of the base layer opposite the extended end of the barrier structures.

Other embodiments may become apparent to one of ordinary skill in the relevant field of art in response to a review of the specification and drawings.

### BRIEF DESCRIPTION OF THE DRAWINGS

FIG. 1 is a schematic diagram showing a cross-sectional side view of a barrier article comprising an embodiment in accordance with the invention;

FIG. 2 is a schematic diagram showing configurations of barrier structures disposed in a barrier layer according to embodiments of the invention;

FIG. 3 is a schematic diagram showing a frangible barrier structure disposed in a barrier layer according to embodiments of the invention;

FIG. 4 is a schematic diagram showing a barrier article comprising an embodiment of the invention.

### DETAILED DESCRIPTION

The invention includes embodiments that may relate to a barrier article and/or a defensive article or barrier article. The invention includes embodiments that may relate to a method of making and/or using the articles.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified.

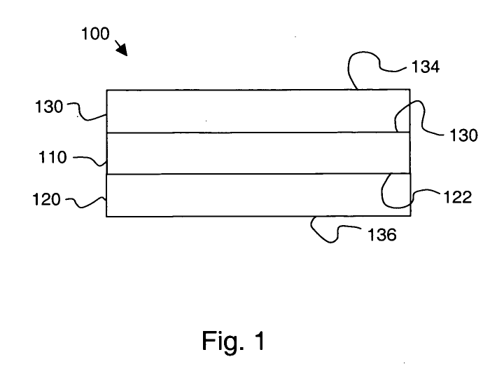

An article 100 comprising an embodiment according to the invention is shown in FIG. 1. The article 100 may include a base layer 110, an adhesive layer 120 secured to a first surface 122 of the base layer 110, and a defensive or barrier layer 130 secured to a second surface 132 of the base layer 110, opposite the adhesive layer 120. The barrier layer 130 may include an exposed or exposable surface 134, and the adhesive layer may include a contact surface 136.

The base layer 110 in the embodiment illustrated in FIG. 1 may be formed of a flexible, metal-fiber reinforced thermoplastic polymer having a relatively high glass transition temperature (Tg). The base layer 110 may be about 50 micrometers thick and may include filler materials that increase toughness and heat resistance. The adhesive layer 120 may be formed of thermosetting polymeric adhesive having very high adhesion strength and a high glass transition temperature. The adhesive layer 120 may be about 50 micrometers thick, and may include filler materials that increase toughness and heat resistance. The barrier layer 130 may be formed of metal and defines clusters of sharp projections that extend away from the base layer 110 at differing angles to the sharp free end. Some of the projections may have barbed ends.

A base layer, in accordance with embodiments of the invention, may include one or more of thermoplastic polymer, thermoset polymer, metal, cellulosic material, and the like. A base layer may be a film, a sheet, or stock, and may be substantially uniform in thickness or may be thicker in someplace, and relatively thinner in other places. Films, sheets, and stock may be differentiated from each other based on average thickness. Films may have a thickness in a range of less than about 25 micrometers (10 mils), sheets may have a thickness in a range of from about 25 micrometers (10 mils) to about 250 micrometers (100 mils), and stock may be anything thicker than sheets.

A base layer may include one or more polymeric material or polymer, and may further include one or more of filler, additive, or pigment. A suitable polymer may include a thermoplastic material, a thermosetting material, or both, and may include a synthetic polymer, a naturally occurring polymer, or both.

Suitable binders, resins, monomers, or polymers (hereinafter collectively “polymers”) for use in forming a base layer may include thermoplastic material, thermoset material, or a combination of both. In one embodiment, a polymer may include one or more of polyacrylamide, polyacrylate, polyamide, polycarbonate, epoxy, polyester, polyether, ionomer, polyimide, polyolefin, polystyrene, polyurethane, polyvinyl, silicone, polysiloxane, or norbornene polymer.

Suitable polyamide polymers may include polymers commercially available from EMS American Grilon Inc., (Sumter, S.C.) under the tradename GRIVORY such as CF₆S, CR-9, XE3303 and G-21. GRIVORY G-21 may be an amorphous nylon copolymer having a glass transition temperature (Tg) of 125 degrees Celsius, a melt flow index of 90 g/10 min and an elongation at break of 15. Elongation at break may be determined with reference to ASTM D638, which is hereby incorporated by reference in its entirety. GRIVORY CF₆₅ may be a nylon 6/12 film grade polymer having a melting point of 135 degrees Celsius, an MFI of 50 g/10 min, and an elongation at break in excess of 350%. GRILON CR9 may be a nylon 6/12 film grade polymer having a melting point of 200 degrees Celsius, an MFI of 200 g/10 min, and an elongation at break at 250%. GRILON XE 3303 may be a nylon 6.6/6.10 film grade polymer having a melting point of 200 degrees Celsius, an MFI of 60 g/10 min, and an elongation at break of 100%. Suitable polyamide polymers may include those available from, for example, Union Camp, Inc. (Wayne, N.J.) under the UNI-REZ product line, and dimer-based polyamide polymers available from Henkel of America, Inc. (Gulph Mills, Pa.) under the VERSAMID product line. Suitable polyamides may include those produced by condensing dimerized vegetable acids with hexamethylene diamine.

Suitable polycarbonates may include those commercially available from the CALIBRE, from Dow Chemical Co. (Midland, Mich.), LEXAN, from GE Plastics (Pittsfield, Mass.), and MAKROLON, from Bayer Corporation (Pittsburgh, Pa.). Other suitable polycarbonates may be obtained by a reaction of bisphenol A and carbonyl chloride in an interfacial process. Suitable molecular weight may be less than about 20,000, in a range of from about 20,000 to about 35,000, or greater than about 35,000; and a suitable melt flow rate may be less than about 5 g/10 min, in a range of from about 5 to about 20 g/10 min, or greater than about 20 g/10 min.

Suitable polyesters may include one or both of polyethylene terephthalate (PET) or PETG (PET modified with cyclohexanedimethanol). Polyesters may be obtained commercially, such as KODAR 6763, a PETG available from Eastman Chemical (Rochester, N.Y.), or SELAR PT-8307 a PET available from DuPont Corporation (Wilmington, Del.). Other suitable polyesters may be prepared from various glycols or polyols and one or more aliphatic or aromatic carboxylic acids.

An ionomer is a polyolefin containing ionic bonded molecular chains. In one embodiment, ionomers may be used. Suitable ionomers may include ionomeric ethylene copolymers such as SURLYN 1702 or SURLYN 1706, both available from DuPont, and which may include an inter-chain ionic bond based on a zinc salt of ethylene methacrylic acid copolymer.

Suitable polyolefins may include one or more of: polyethylene or polypropylene, or a polymer or copolymer having ethylene or propylene units; oxygenated ether, oxygenated butadiene, or oxygenated isoprene; halogenated ether, halogenated butadiene, or halogenated isoprene; butadiene derivatives, such as butadiene-styrene, butadiene-isoprene-styrene, butadiene-vinyl-styrene, butadiene-vinyl-toluene, butadiene-isoprene-toluene, and the like; polyacrylate or polymethacrylate, or a polymer or copolymer having acrylic or methacrylic units; acrylonitrile; vinylic hydrocarbon polymers reacted with unsaturated materials such as the reaction product of maleic acid with styrene, or maleic anhydride with styrene; and, polymeric, rubber-like, elastomeric latex polymers and copolymers of ethylenically unsaturated polymers and polymers obtainable in stable aqueous latex form. In one embodiment, a halogenated polyolefin may include fluoroethylene, such as polytetrafluoroethylene.

Suitable polyolefins may be characterized as having a melt index or melt flow rate of less than about 10, in a range of from about 10 to about 20, or greater than about 30 as determined by ASTM Test Method 1238, which is hereby incorporated by reference in its entirety. A polyolefin may include polymers and copolymers of ethylene, propylene, 1-butene, and the like, and may further include blends and mixtures of such polymers and copolymers.

Suitable polyethylene polyolefins may include low, medium, or high density polyethylene, or combinations of two or more thereof. A low density range for a polyethylene may in a range of from less than about 0.910 grams per cubic centimeter (g/cm³) to about 0.925 g/cm³, a medium density range may be from about 0.925 g/cm³ to about 0.940 g/cm³, and a high density range may be from about 0.940 g/cm³ to greater than about 0.965 g/cm³. A low density polyethylene (LDPE) may be REXENE 1017, which is commercially available from Huntsman Corporation (Houston, Tex.).

Suitable propylene polyolefins may include polypropylene homopolymer, or a copolymer, such as propylene-ethylene or propylene-1-butene copolymer. Blends of polypropylene and polyethylene with each other, or blends of either or both of them with a polypropylene-polyethylene copolymer may be used. The polyolefin film forming materials may have a high propylenic content, either polypropylene homopolymer or propylene-ethylene copolymers or blends of polypropylene and polyethylene with low ethylene content, or propylene-1-butene copolymers or blend of polypropylene and poly-1-butene with low butene content.

Suitable propylene homopolymers may have a melt flow rate (MFR) from about 0.5 to about 20 as determined by ASTM Test D 1238, condition L. In one embodiment, propylene homopolymers may have a melt flow rate (MFR) or a melt flow index (MFI) of less than about 4 grams per 10 minutes (g/10 min), and in a range of from about 4 g/10 min to about 8 g/10 min, from about 8 g/10 min to about 10 g/10 min, or greater than about 10 g/10 min. Here and throughout the specification and claims, range limitations may be combined and interchanged, for example, the above MRF or MFI range may be from less than about 4 g/10 min to greater than about 10 g/10 min. As used herein, MFR and MFI may be determined with reference to DIN 53735, which is hereby incorporated by reference in its entirety. Suitable propylene homopolymers may have a density less than about 0.8 g/cm³, in a range of from about 0.8 g/cm³ to about 0.9 g/cm³, or greater than about 0.9 g/cm³. Commercially available propylene homopolymers may include 5A97, available from Union Carbide Corporation (Danbury, Conn.), which has an MFR of 12.0 g/10 min and a density of 0.90 g/cm³; DX5E66, also available from Union Carbide, has an MFI of 8.8 g/10 min and a density of 0.90 g/cm³; and WRD5-1057 from Union Carbide having an MFI of 3.9 g/10 min and a density of 0.90 g/cm³.

Suitable polystyrene may include homopolymers and/or copolymers of styrene, and may include substituted styrene such as alpha-methyl styrene. Examples of suitable styrene copolymers and terpolymers may include one or more of acrylonitrile-butene-styrene (ABS), styrene-acrylonitrile copolymers (SAN), styrene butadiene (SB), styrene-maleic anhydride (SMA), or styrene-methyl methacrylate (SMMA), and the like.

A suitable polymer may include one or more polyurethane. Suitable polyurethanes may include diphenylmethane diisocyanate, methylene diethyl diisocyanate, isocyanurate. Suitable polyurethanes may include aliphatic polyurethanes. Other suitable polyurethanes may include aromatic polyurethanes. Polyurethanes having a cyclic moiety may be suitable, and combinations of one or more of aliphatic, aromatic, or cyclic may be suitable also.

In one embodiment, a vinyl polymer, such as alkylene vinyl acetate polymers (e.g., EVA polymer) may be used. Suitable commercially available vinyl polymers may include ESCORENE UL-7520, a copolymer of ethylene with 19.3% vinyl acetate; and NUCRELL 699), an ethylene copolymer containing 11% of methacrylic acid. ESCORENE and NUCRELL are available from Exxon Mobil Corporation (Irving, Tex.) and DuPont Corporation, respectively. In addition, suitable vinyl polymers may include one or more of vinyl-based and/or vinylidene-based polymers or copolymers. In one embodiment, a vinyl polymer may include one or more of polyvinyl chloride, polyvinyl butyral, polyvinyl acetal, polyvinyl acetoacetal, polyvinylidene fluoride, polyvinylidene chloride, polyvinyl alcohol, or polyethylene vinyl alcohol, and the like, and combinations of two or more thereof.

Suitable polysiloxanes may be entirely inorganic, may have an inorganic backbone with organic side groups, or may be formed from organic modified precursors. In one embodiment, a suitable siloxane may include an alkoxy moiety, a glycidyl or epoxy moiety, a cyano or cyanato moiety, an amino moiety, a mercapto moiety, or a combination of moieties that include two or more thereof. Suitable organic side groups may include from about 1 to about 100 carbon atoms and may have an aliphatic, cyclic and/or aromatic character. Suitable organic modified precursors for the polysiloxane include acrylic, urethane and epoxy functional polymers or oligomers.

A suitable polysiloxane may be formed using a sol-gel process or a condensation reaction, particular from silane precursors. A siloxane according to one embodiment may be air-dried at room temperature, or may be heat dried, or heat cured. In one embodiment, the siloxane may be polymerized or cured by exposure to radiation. Suitable radiation may include one or more of ultraviolet, infrared, electron beam, and/or visible light. Cross linking or curing of the siloxane material may depend on the choice of siloxane material and the functionality thereof. In one embodiment, the siloxane may be chemically initiated to form linkages. Commercially available cross linking or curing methods may be determined with reference to the selection of siloxane material, and may include ambient cure systems, thermal cure systems, radiation cure systems, moisture cure systems, and one and two part curing agent or cross link initiating systems.

In one embodiment, a silane and/or polysilane may have an alkoxy moiety, such as mono, di, tri, and tetralkoxy functionality. For example, preselected alkoxy silanes may be mixed with water to hydrolyze the alkoxysilane into silanol and alcohol. In one embodiment, a suitable silane may include a glycidyl moiety, an amino moiety, a cyano or cyanato moiety, a mercapto moiety, or a combination of moieties that include two or more thereof. In one embodiment, the silane may include one or more of glycidoxyproyl trimethoxy silane, 1,2 bis(triethoxysilyl) ethane, gamma-aminopropyl triethoxy silane, mercaptoproyl trimethoxy silane, polydimethylsilane, vinyl silane, aminopropyl silane, epoxy silane, or vinyl triactosilane. A suitable silane may include a non-hydrolyzable functional group. Such groups may include amino, vinyl, ureido, epoxy, mercapto, isocyanato, methacrylato, vinylbenzene and sulfane functional groups. Examples of suitable silanes may include vinyltrimethoxysilane, bis-triethoxysilylpropyl tetrasulfane, amino trimethoxysilane, and ureidopropyl trimethoxysilane. Other examples of suitable silanes may include 1,2 bis-(triethoxysilyl) ethane, 1,2-bis-(trimethoxysilyl) ethane, 1,6-bis-(trialkoxysilyl) hexane, 1,2-bis-(triethoxysilyl) ethylene, or bis-triethoxysilylpropyl tetrasulfane.

Suitable polysiloxanes may include ADSIL AD-65 or ADSIL AD-95, which are commercially available from Adsil Corporation (Palm Coast, Fla.). In one embodiment, a suitable silicon-containing material may include SDC TECH MP-100, which is commercially available from SDC Technologies, Inc. (Anaheim, Calif.). A suitable silane may include an ECOSIL brand product, which may be obtained from Epro Services, Inc. (Derby, Kans.).

In one embodiment, a suitable polymer for use in a base layer may include one or more of urea formaldehyde, phenolformaldehyde, phenolic polymers, carbon-carbon composites, or fibrin polymers, and the like.

In one embodiment, the metal base layer may be a foil, a plate, or a metal film or sheet. Suitable metal for the base layer may include aluminum, antimony, arsenic, barium, bismuth, beryllium, boron, cadmium, calcium, cerium, cesium, chromium, cobalt, copper, germanium, gold, holmium, iridium, iron, lanthanum, lead, lithium, magnesium, manganese, mercury, molybdenum, neodymium, nickel, niobium, osmium, platinum, phosphorous, potassium, praseodymium, rhenium, rubidium, selenium, silicon, silver, sodium, steel, strontium, tantalum, tellurium, thallium, thorium, tin, titanium, tungsten, uranium, vanadium, zinc, or zirconium; or oxides thereof; or mixtures or alloys thereof.

In one embodiment, the ceramic or cermet base layer may be a foil, a plate, or a metal film or sheet. In one embodiment, the base layer may be a ceramic coated metal object. Cermet includes materials that have metal bonded ceramic particles fired at an elevated temperature, and ceramic includes non-metallic minerals fired at an elevated temperature and refers also to enamel.

Suitable ceramic and cermet materials may include aluminum, antimony, arsenic, barium, bismuth, beryllium, boron, cadmium, calcium, cerium, cesium, chromium, cobalt, copper, germanium, gold, holmium, Iron, lanthanum, lead, lithium, magnesium, manganese, molybdenum, neodymium, nickel, niobium, osmium, platinum, phosphorous, potassium, praseodymium, rhenium, rubidium, selenium, silicon, silver, sodium, strontium, tantalum, tellurium, tin, titanium, tungsten, uranium, vanadium, zinc, or zirconium; or alloys thereof; or halides, sulfides, nitrides, oxides or carbides thereof.

In one embodiment, suitable ceramics may include one or more of aluminum triethoxide, aluminum isopropoxide, aluminum sec-butoxide, aluminum tri-t-butoxide, magnesium trifluoroacetylacetonate, magnesium methoxide, magnesium ethoxide, titanium methoxide, titanium ethoxide, titanium isopropoxide, titanium propoxide, titanium butoxide, titanium ethylhexoxide, titanium (triethanolaminato) isopropoxide, titanium bis(ethyl acetoacetato) diisopropoxide, titanium bis(2,4-pentanedionate) diisopropoxide, zirconium ethoxide, zirconium isopropoxide, zirconium propoxide, zirconium sec-butoxide, zirconium t-butoxide, aluminum di-s-butoxide ethylacetonate, calcium methoxyethoxide, calcium methoxide, magnesium methoxyethoxide, copper ethoxide, copper methoxyethoxyethoxide, antimony butoxide, bismuth pentoxide, chromium isopropoxide, tin ethoxide, zinc methoxyethoxide, titanium n-nonyloxide, vanadium tri-n-propoxide oxide, vanadium triisobutoxide oxide, iron ethoxide, tungsten ethoxide, samarium isopropoxide, iron isopropoxide, cobalt methoxyethoxide, or lanthanium methoxyethoxide.

Suitable base layers, generally, may be flexible, rigid, or brittle. In one embodiment, a flexible base layer may be conformable, and in another embodiment may be non-conformable. A conformable base layer may be elastic or may be inelastic, and may, for example, stretch to accommodate surface irregularities during application to the surface, stretch to accommodate trapped material such as air, water or dirt during application to a surface, and/or stretch to accommodate movement in a substrate to which it is applied where the movement may result from thermal expansion, vibration, and the like.

A rigid base layer may be, in one embodiment, similar to floor coverings, such as tiles or linoleum, in configuration, installation and use. In another embodiment, a rigid base layer may be plate-like insofar as substrate surface areas may be covered using a plurality of barrier article units that are plate-like, and which provide a relatively increased resistance to removal and/or tamper attempts. In one embodiment, a rigid base layer may be formed from metal, ceramic, or both. In an alternative embodiment, a base layer, particularly a rigid base layer, may further include anchor structures to assist or enhance an adhesive layer in securing a barrier article to a substrate surface. Suitable anchor structures may include fasteners, tacks, pegs, anchors, screws, barbs, and the like, and combinations of two or more thereof.

An adhesive layer for use in embodiments of the invention may include a curable adhesive, a structural adhesive, a pressure sensitive adhesive, and the like, or a combination of two or more thereof. In one embodiment, an adhesive layer may include an emulsion-based adhesive or a solvent-based adhesive. In one embodiment, the adhesive may be a hot-melt adhesive. In one embodiment, the adhesive may be a pressure-activated adhesive. A suitable adhesive for use in an adhesive layer may include one or more of hot-melt adhesives, moisture curable adhesives, pressure-activated adhesives, and radiation curable adhesives, and the like. As used herein, a structural adhesive, when fully adhered to a substrate, has an adhesive strength equal to or greater than the cohesive strength of the adhesive, the substrate, or both. A pressure-activated adhesive may have a curing agent or initiator admixed within, and may respond to pressure by releasing the curing agent or initiator and thereby begin a curing process of the adhesive. Solvent-based adhesives may include those adhesives that form adhesive properties in response to an evaporation or loss of a solvent initially contained in the adhesive. A hot melt adhesive may flow and liquefy under high temperatures, and may form adhesive properties upon cooling.

In one embodiment, a method of making a suitable adhesive may include: (1) preparing a polymer mixture comprising one or more polymerizable polymers; (2) polymerizing the polymer mixture to form a polymerized mixture; (3) modifying the polymerized mixture with a modifying polymer; and (4) neutralizing the resulting modified mixture.

A suitable adhesive layer may have a patterned thickness, or a substantially uniform thickness, of less than about 25 micrometers, in a range of from about 25 to about 35 micrometers, from about 35 micrometers to about 50 micrometers, or greater than about 50 micrometers.

In one embodiment, an adhesive layer may be continuous. In one embodiment, an adhesive layer may be discontinuous. A discontinuous adhesive layer define a pattern of areas having adhesive and other areas that are adhesive-free, or substantially adhesive-free. Alternatively or additionally, an adhesive layer may include two or more adhesives having differing properties. For example, a first adhesive with a relatively strong adhesive strength may be disposed in some areas, but a second adhesive with a relatively weak adhesive strength may be disposed in other areas. In one embodiment, first and second adhesive materials are disposed at different heights relative to each other. A weak adhesive may protrude further than a strong adhesive, so that the weak adhesive may contact a substrate first during an application. In such a situation, the weak adhesive layer may provide initial tack for positioning, but may allow slight movement of the laminate to allow positioning adjustments prior to the stronger adhesive forming a relatively more permanent bond. Such an arrangement may facilitate slideability, repositioning, smoothing, and/or air egress.

A suitable adhesive layer may include two or more differing adhesives. In one embodiment, an adhesive layer may include a pressure sensitive adhesive (PSA), and may further include one or more of a moisture activatable adhesive, a hot-melt adhesive, a two-component adhesive as described herein, a solvent or water-based adhesive, or a heat activatable adhesive layer. In one embodiment, differing adhesive are commixed or commingled, and in one embodiment, differing adhesives may be substantially unmixed, but in the same adhesive layer. In one embodiment, an adhesive layer may be discontinuous, and differing adhesive materials may be disposed throughout portions of the discontinuous adhesive layer to provide differing adhesive functionality.

In one embodiment, a curing adhesive may be a radiation-initiated adhesive. Suitable radiation-initiated adhesives may include ultraviolet (UV) curable adhesives and electron beam (EB) curable adhesives, also, heat and infrared (IR) curable adhesives may be included. Suitable chemical-initiated adhesives may include

A suitable curing adhesive may include chemically activated two-part adhesives, which may by cured by contact with a surface primer or adhesion initiator. Suitable two-component adhesives for use with an adhesion initiator may include a thermosetting, anaerobically curable polymeric polymer system that may contact the adhesion initiator and cure in response to contacting the same. Suitable adhesion initiators may include an organocopper catalyst, such as LOCTITE 7469 PRIMER, which is commercially available from Henkel Loctite Corp. (Rocky Hill, Conn.). In other embodiments, suitable alternative adhesion initiators may include other metallic catalysts, such as organo-iron catalysts, zirconium complexes (such as K-KAT XC-9213), metal chelates (such as NACURE XC-9206), and antimony-based catalysts (such as NACURE XC-7231), all of which are commercially available from King Industries, Inc. (Norwalk, Conn.). Other suitable adhesion initiators in alternative embodiments may include nitrogen and sulfur based catalysts.

A suitable adhesive for use in an adhesive layer may include one or more polymer selected from acrylates, amides, acrylonitriles, carbonate, cyanate esters, cyanurates, ethylene-vinyl acetate, epoxy, fluoroplastics, ionomers, methyl methacrylates, non-ethylenic olefin polymers (linear or branched), nylon, olefins, polyester, styrene, styrene-maleic anhydride, sulfones, styrene-acrylonitrile, urethanes, and combinations of two or more thereof. In one embodiment, an adhesive may include an ethylenically unsaturated polymer that is capable of undergoing polymerization or copolymerization. As used herein, binder, resin, monomer, and unsaturated polymer may be collectively referred to collectively as a polymerized end product or “polymer”.

As noted above, a suitable adhesive may include an acrylate polymer. A suitable acrylate may include those derived from ethylene methacrylic acid, ethylene methyl acrylate, ethylene acrylic acid and ethylene ethyl acrylate. Additional suitable acrylic polymers may include ethoxylated trimethylol propane triacrylate, trimethylol propane trimethacrylate, dipentaerythritol monohydroxy pentacrylate, pentaerythritol triacrylate, ethoxylated trimethylol propane triacrylate, 1,6-hexanedioldiacrylate, neopentyl glycol diacrylate, pentaerythritol tetraacrylate, 1,2-butylene glycoldiacrylate, trimethylopropane ethoxylate trimethacrylate, glyceryl propoxylate trimethacrylate, trimethylolpropane trimethacrylate, dipentaerythritol monohydroxy pentamethacrylate, tripropylene glycol dimethacrylate, neopentyl glycol propoxylate dimethacrylate, 1,4-butanediol dimethacrylate, polyethylene glycol dimethacrylate, triethyleneglycol dimethacrylate, butylene glycol dimethacrylate, ethoxylated bisphenol A dimethacrylate, and the like, and combinations of two or more thereof.

In one embodiment, an acrylic polymer may be formed from alkylene glycol diacrylate polymers. Such alkylene glycol diacrylate polymers may be selected from mono-, di-, tri-, tetra- and polyethylene glycol dimethacrylate and corresponding diacrylates; dipentamethylene glycol dimethacrylate; tetraethylene glycol dichloroacrylate; diglycerol diacrylate; diglycerol tetramethacrylate; butylene glycol dimethacrylate; neopentyl glycol diacrylate; and trimethylopropane triacrylate. In one embodiment, suitable amino polymers may include substituted and/or unsubstituted aminoalkyl acrylates, hydrochloride salts of amino polymers, and methacrylates, such as beta-amino ethylacrylate, beta-amino ethyl ethacrylate, dimethyl amino methylacrylate, beta-methyl amino ethylacrylate, and dimethyl amino methylmethacrylate.

In one embodiment, an alkyl acrylate and/or methacrylate may include from about 4 carbon atoms to about 10 carbon atoms, from about 10 carbon atoms to about 20 carbon atoms, or more than about 20 carbon atoms. An acrylate may be copolymerized with a modifying polymer (for example, a second acrylic ester) and/or polymers with predetermined functional groups (e.g., acrylic, methacrylic, itaconic acids, and amides thereof). Suitable polymers may include butyl acrylate, 2-ethylhexyl acrylate, and iso-octyl acrylate.

In one embodiment, an acrylate polymer may include further one or more functional oxiranyl (oxirane) groups. In one embodiment, an acrylate polymer may include further one or more functional urethane groups, such as in a urethane-acrylate-capped prepolymer, which may be based on polybutadiene polyols, or based on polyamines and acrylates.

In one embodiment, a monofunctional acrylate ester (esters containing one acrylate group) may be used. A suitable acrylate ester may have a relatively polar moiety. Polar groups may be selected from labile hydrogen, heterocyclic ring, hydroxy, amino, cyano, and halogen polar groups; examples may include cyclohexyl methacrylate, tetrahydrofurfuryl methacrylate, hydroxyethyl acrylate, hydroxypropyl methacrylate, t-butylaminoethyl methacrylate, cyanoethylacrylate, and chloroethyl methacrylate. Acrylate esters may be incorporated as reactive diluents capable of copolymerizing with various other polymerizable materials.

Suitable amides of carboxylic acids may include unsubstituted amides such as methacrylamide, alpha-substituted acrylamides, and n-substituted amides obtained by the reaction of the amides of the aforementioned carboxylic acids with an aldehyde (e.g., formaldehyde). In one embodiment, n-substituted amides may include one or more of n-methylol acrylamide, n-methylol methacrylamide, alkylated n-methylol acrylamides, and n-methylol methacrylamides (e.g., n-methyoxymethylacrylamide and n-methoxy methyl methacrylamide). Suitable nitriles, that is, ethylenically unsaturated carboxylic acids, may include acrylonitrile, alpha-chloroacrylonitrile, and methacrylonitrile.

Suitable polyepoxide resins may be solid or liquid at room temperature. Suitable epoxides may include linear polymers having terminal epoxide groups (e.g., the diglycidyl ether of bisphenol-A), polymers having pendent epoxy groups (e.g., polyglycidyl ethers of phenolic novolak compounds), or both.

In one embodiment, an adhesive may include one or more of aromatic epoxy, aliphatic epoxy, or cycloaliphatic epoxy, and may have multiple epoxy functional groups. Suitable aromatic polyepoxides may include two or more 1,2-cyclic ethers. Such compounds may be aromatic or heteroaromatic, or a combination thereof. Aromatic polyepoxide may be included in an adhesive layer to increase the glass transition temperature (Tg) of a cured adhesive layer and to provide heat resistance.

Suitable aromatic epoxides (i.e., compounds containing at least one aromatic ring structure, e.g., a benzene ring, and at least two epoxide groups) may include one or more of polyglycidyl ethers of polyhydric phenols, such as Bisphenol-A or Bisphenol-F type resins and their derivatives, aromatic polyglycidyl amines (e.g., polyglycidyl amines of benzenamines, benzene diamines, naphthylenamines, or naphthylene diamines), polyglycidyl ethers of phenol formaldehyde resole or novolak resins; resorcinol diglycidyl ether; polyglycidyl derivatives of fluorene-type resins; and glycidyl esters of aromatic carboxylic acids, e.g., phthalic acid diglycidyl ester, isophthalic acid diglycidyl ester, trimellitic acid triglycidyl ester, and pyromellitic acid tetraglycidyl ester.

In one embodiment, an aromatic polyepoxide may include polyglycidyl ethers of polyhydric phenols, such as the series of diglycidyl ethers of Bisphenol-A, commercially available from Resolution Performance Products, Inc. (Houston, Tex.), for example, under the trade designations “EPON 828” and “EPON 1001F” and the series of diglycidyl ethers of Bisphenol-A and Bisphenol F and their blends, commercially available from Resolution Performance Products, Ltd. (Pernis, The Netherlands), for example, under the trade designations “EPIKOTE 232” and “EPIKOTE 1001”. Other useful commercially available aromatic epoxides include the “DER” series of Bisphenol epoxides and “DEN” series of epoxy novolak resins, available from Dow Chemical Corporation (Midland, Mich.); diglycidyl ether of fluorene Bisphenol, available from Resolution Performance Products, under the trade designation “EPON HPT Resin 1079”; a triglycidyl derivative of p-aminophenol, commercially available from Ciba Performance Polymers, Inc. (Brewster, N.Y.), under the trade designation “MY 0500”; a tetraglycidyl derivative of methylene dianiline, commercially available from Ciba Performance Polymers, under the trade designation “MY 720”; and a polyfunctional aromatic epoxide resin commercially available from Resolution Performance Products under the trade designation “EPON SU-8.” Flame retardant epoxides may also be used, for example, the flame retardant brominated Bisphenol-A diglycidyl ether, commercially available from Dow Chemical Corporation, under the trade designation “DER 580”. The term “derivative” as used herein with reference to thermosetting materials refers to a base molecule with additional substituents that do not interfere substantially with the thermosetting curing reaction of the base molecule.

In one embodiment, an adhesive may include one or more of N,N″-diglycidyl-p-aminophenyl-glycidyl ether, triglycidyl p-aminophenol derived resins, 1,3,5-triglycidyl isocyanurate, tetraglycidylmethylenedianiline, or a glycidyl ether derivative of a novolac resin.

Suitable methacrylic acid esters may include one or more C1-C17 alkyl methacrylates. In one embodiment, methacrylic esters may include methyl methacrylate, ethyl methacrylate, isopropyl methacrylate, n-butylmethacrylate, isobutylmethacrylate, hexyl acrylate, 2-ethylhexyl methacrylate, t-butyl methacrylate, 3,3-dimethylbutyl methacrylate, and lauryl acrylate.

Suitable adhesives may include block copolymers of vinyl aromatic hydrocarbons and conjugated dienes. Block copolymers may be diblock, triblock, multiblock, starblock, polyblock or graftblock copolymers. Throughout the specification and claims, the term ‘block’, as used in diblock, triblock, multiblock, polyblock, and graft or grafted block, refers to the polymer building block used to make the block copolymer. Such block copolymers may have structures represented by the formulae AB, ABA, ABAB, BAB, ABBA, and the like, where A may be a hard or crystalline polymer block of, for example, a vinyl aromatic hydrocarbon or a conjugated diene/vinyl aromatic hydrocarbon tapered copolymer block; and B may a rubbery polymer block of, for example, a conjugated diene. Suitable multi block copolymers may include linear and/or radially symmetric, and/or linear and/or radially asymmetric copolymers.

In one embodiment, an adhesive may include rubber based elastomer materials such as linear, branched, graft or radial-block copolymers represented by the diblock structures A-B, the triblock A-B-A, the radial or coupled structures (A-B)n, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may include from about 75% to about 95% by weight of rubbery segments and from about 5% to about 25% by weight of non-rubbery segments.

The non-rubbery segments or hard blocks include polymers of mono- and polycyclic aromatic hydrocarbons, and more particularly vinyl-substituted aromatic hydrocarbons which may be monocyclic or bicyclic in nature. The rubbery blocks or segments are typically polymer blocks of homopolymers or copolymers of aliphatic conjugated dienes. Rubbery materials such as polyisoprene, polybutadiene, and styrene butadiene rubbers may be used to form the rubbery block or segment. The rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

Suitable block copolymers may be prepared using one or more of sequential addition of polymer, incremental addition of polymer, or coupling techniques. Tapered copolymer blocks can be incorporated into multiblock copolymers, for example, by copolymerizing a mixture of conjugated diene and vinyl aromatic hydrocarbon polymers utilizing a difference in copolymerization reactivity rates.

In one embodiment, a conjugated diene may be utilized to prepare an adhesive polymer and/or copolymer. Suitable conjugated dienes may from 4 carbon atoms to about 6 carbon atoms, or from about 6 carbon atoms to about 10 carbon atoms, or more than about 10 carbon atoms. Examples of suitable conjugated dienes may include one or more of 1,3 butadiene, 2 methyl 1,3 butadiene (isoprene), 2,3 dimethyl 1,3 butadiene, chloroprene, 1,3 pentadiene, 1,3 hexadiene, and the like. In one embodiment, an adhesive polymer may include a conjugated diene selected from isoprene, 1,3 butadiene, or both.

Examples of suitable vinyl aromatic hydrocarbons which may be utilized to prepare copolymers may include styrene and/or a substituted styrene or styrene derivative. Suitable styrene derivatives may include o-methylstyrene, p-methylstyrene, p-tert butylstyrene, 1,3-dimethylstyrene, alpha methylstyrene, beta methylstyrene, p-isopropylstyrene, 2,3 dimethylstyrene, o-chlorostyrene, p-chlorostyrene, o-bromostyrene, 2-chloro-4-methylstyrene, and the like. In one embodiment, an adhesive polymer may include styrene.

A number average molecular weight of suitable block copolymers, for example prior to hydrogenation, may be less than about 20,000, in a range of from about 20,000 to about 40,000, from about 40,000 to about 300,000, from about 300,000 to about 500,000, or greater than about 500,000. An average molecular weight of the individual blocks within a copolymer may pre-selected with reference to application specific criteria. In one embodiment, a vinyl aromatic block may have a number average molecular weight of less than about 2000, in a range of from about 2000 to about 4000, from about 4,000 to about 60,000, from about 60,000 to about 125,000, or greater than about 125,000. A conjugated diene block may have number average molecular weight of less than about 10,000, in a range of from about 10,000 to about 35,000, from about 35,000 to about 150,000, from about 150,000 to about 450,000, or greater than about 450,000.

In one embodiment, a block copolymer may contain a ratio of conjugated diene to vinyl aromatic hydrocarbons having less than about 40 weight percent, from about 40 weight percent to about 50 weight percent, or greater than about 50 weight percent of conjugated diene relative to vinyl aromatic hydrocarbon.

Prior to hydrogenation, a vinyl content of a conjugated diene portion may be less than about 10 weight percent, in a range of from about 10 weight percent to about 80 weight percent, or may be greater than about 80 weight percent. Vinyl content may be less than about 25 weight percent, in a range of from about 25 weight percent to about 35 weight percent, from about 35 weight percent to about 55 weight percent, or may be greater than about 55 weight percent. In one embodiment, an elasticity of a modified block copolymer may be controlled by pre-selecting a vinyl content thereof. Vinyl content of the block copolymer may be determined, for example, using nuclear magnetic resonance.

Examples of suitable diblock copolymers (AB-type) may include one or more of styrene-butadiene (SB), styrene isoprene (SI), and hydrogenated derivatives thereof. Examples of suitable triblock polymers (ABA-type) may include one or more of styrene butadiene styrene (SBS), styrene isoprene styrene (SIS), styrene-butadiene-isoprene (SBI), or methylstyrene-isoprene-methylstyrene (MIM). Upon hydrogenation of the SBS copolymers comprising a suitable mixture of 1,4 and 1,2 isomers, a styrene-ethylene-butylene styrene (SEBS) block copolymer is obtained. Hydrogenation of an SIS polymer may yield a suitable styrene-ethylene-propylene-styrene (SEPS) block copolymer. VECTOR 4111 is a suitable SIS block copolymer (ABA-type), which is commercially available from Dexco Corporation (Houston Tex.). In one embodiment, a conjugated diene portion of the block copolymer may be about 90% saturated, or may be from about 90% to about 95% saturated, or may be more saturated than about 95%.

In one embodiment, the selectively hydrogenated block copolymer may have a structure as shown below in formula (I):
Bₙ(AB)ₒAₚ (I)
where n=0 or 1; o=1 to 100; p=0 or 1; each B prior to hydrogenation may be a polymerized conjugated diene hydrocarbon block, and may have a number average molecular weight in a range of from about 20,000 to about 450,000; and, each A may be a polymerized vinyl aromatic hydrocarbon block, and may have a number average molecular weight in a range of from about 2000 to about 115,000. In one embodiment, blocks of A may constitute about 5% to about 95% by weight of a copolymer; and, an unsaturation of block B may be less than about 10% of an original unsaturation level. In other embodiments, unsaturation of block B may be reduced, relatively, upon hydrogenation to less than 5% of the original value, and the average unsaturation of the hydrogenated block copolymer may be reduced to less than 20% of the original value.

Suitable commercially available maleated and selectively hydrogenated copolymers of styrene and butadiene include KRATON brand products, which are commercially available from Kraton Polymers (Houston, Tex.). KRATON D, G, FG, IR and Liquid polymers include styrenic block copolymers (SBCs) based on feedstocks of styrene, butadiene and isoprene. In one embodiment, styrene may be polymerized with butadiene, isoprene, or both. KRATON D polymers may be elastic and flexible. KRATON G polymers may be SBCs with a hydrogenated midblock, and may be elastic, flexible, and include enhanced oxidation and weather resistance, higher service temperatures and a relatively increased processing stability. KRATON FG polymers may have improved adhesion to polar substrates such as metals and nylons. KRATON IR polymers may include anionically polymerized polyisoprene rubbers, which may yield polyisoprene rubbers with a relatively low gel content and chemical impurity level. Other suitable block copolymers may be commercially available from Nippon Zeon Co. (Tokyo, Japan), for example, QUINTAC 3530, which may include a linear styrene-isoprene-styrene (SIS) block copolymer.

In one embodiment, a hydrocarbon polymer may include one or more of styrene compounds (e.g., styrene, carboxylated styrene, or alpha-methyl styrene), ethylene, propylene, butylene, and conjugated dienes (e.g., butadiene, isoprene and copolymers of butadiene and isoprene).

Examples of suitable vinyl and vinylidene halides may include one or more of vinyl chloride, vinylidene chloride, vinyl fluoride and vinylidene fluoride. In one embodiment, a vinyl ester may include aliphatic vinyl esters. Suitable vinyl esters may include one or more of vinyl formate, vinyl acetate, vinyl propionate, vinyl butyrate, vinyl isobutyrate, vinyl valerate, and vinyl caproate. Suitable vinyl esters may include allyl esters of saturated monocarboxylic acids, such as allyl acetate, allyl propionate, and allyl lactate. Suitable vinyl ethers may include one or more of methylvinyl ether, ethylvinyl ether, and n-butylvinyl ether. Suitable vinyl ketones may include one or more of methylvinyl ketone, ethylvinyl ketone, and isobutyl vinyl ketone.

Suitable ethylenically unsaturated polymers may include alkyl esters and dialkyl esters; ethylenically unsaturated carboxylic acids; nitriles, vinyl and vinylidene halides, and amides of unsaturated carboxylic acids; mono- and polyunsaturated hydrocarbon polymers; vinyl esters (e.g., vinyl esters of C1 to C6 saturated monocarboxylic acids); vinyl ethers; and amino polymers. Ethylenically unsaturated monocarboxylic acids may include methacrylic acid, ethacrylic acid, and crotonic acid. Ethylenically unsaturated dicarboxylic acids may include maleic acid, fumaric acid, itaconic acid, and citraconic acid. Suitable ethylenically unsaturated tricarboxylic acids may include aconitic acid, and halogen-substituted derivatives thereof (e.g., alphachloracylic acid), and the anhydrides of these acids (e.g., maleic anhydride and citraconic anhydride). Suitable dialkyl esters of ethylenically unsaturated dicarboxylic acids may include one or more of dimethyl maleate, diethyl maleate, dibutyl maleate, dioctyl maleate, diisooctyl maleate, dinonyl maleate, diisodecyl maleate, ditridecyl maleate, dimethyl fumarate, diethyl fumarate, dipropyl fumarate, dibutyl fumarate, dioctyl fumarate, diisooctyl fumarate, didecyl fumarate, dimethyl itaconate, diethyl itaconate, dibutyl itaconate, and dioctyl itaconate.

As noted hereinabove, an adhesive may include a hot melt adhesive. A suitable hot melt pressure sensitive adhesive may include one or more of HM-1597, HL-2207-X, HL-2115-X, HL-2193-X, which are commercially available from H.B. Fuller Company, (St. Paul, Minn.); or H2187-01, which is commercially available from Ato Findley, Inc. (Wauwatusa, Wis.). Other suitable hot melt pressure sensitive adhesives may include those commercially available from Century Adhesives Corporation (Columbus, Ohio).

The adhesive compositions also may include one or more additives. Suitable additives may include a toughening agent, tackifying polymer, wax, wetting agent, antioxidant, heat stabilizer, light stabilizer, ultraviolet light absorber, filler, colorant, pigment, opacifier, antiblocking agent, reinforcing agent, processing acid, fire retardant additive, biocide, anti-mildew agent, defoamer, flow agent, elastomer, plasticizer, thixotropic agent, suspension agent, water repellant additive, modifier, curing agent, hardening agent, flexibilizer, catalyst, and the like. In one embodiment, an adhesive may include a curing agent or hardener.

A suitable toughening agent may include insoluble in situ polymerized elastomeric particles that are formed from amine terminated polyethers, for example, diprimary amine endcapped poly(tetramethyleneoxides). Other suitable toughening agents may include amine-terminated butadiene/nitrile rubbers, carboxyl-terminated butadiene/nitrile rubbers, and core shell materials.

Suitable tackifying polymers may include a solid tackifier polymer component. A solid tackifier may have a softening point above 80 degrees Celsius. When the solid tackifier polymer component is present, the adhesive compositions may include from about 40 to about 80% by weight of a thermoplastic elastomer component and from about 20% to about 60% by weight, and in one embodiment from about 55 to about 65% by weight of a solid tackifier polymer component. A solid tackifier may reduce the modulus of the mixture to build tack or adhesion. Also, solid tackifiers (particularly the higher molecular weight solid tackifiers may be less sensitive to migration into the polymer base layer, and this is desirable Suitable tackifying polymers may have an average molecular weight of less than about 2000, about 2000, or greater than about 2000; and, may have a dispersity (Mw/Mn) of about 1, in a range of from about 1 to about 2, from about 2 to about 3, or greater than about 3.

Suitable solid tackifier polymers may include polyterpene polymers, hydrocarbon polymers, synthetic tackifier polymer, rosin, hydrogenated rosin, rosin esters, and the like. A suitable polyterpene polymer may include ZONATAC brand polymers from Arizona Chemical Company, Inc. (Jacksonville, Fla.). A suitable petroleum hydrocarbon polymer may include ESCOREZ brand polymer from Exxon Chemical Company. A commercially available synthetic tackifier polymer may include WINGTACK 95 available from Goodyear Corporation (Akron, Ohio).

The adhesive compositions may contain inorganic fillers and other organic and inorganic additives to provide desired properties. Suitable fillers may include one or more of calcium carbonate, titanium dioxide, silicon carbide, metal particles, fibers, and the like. Flame retardants may include one or more of ethylene bis pentabromo biphenyl, brominated bisphenol, halogenated metal oxide, or antimony trioxide.

Suitable modifiers may include one or more vinyl ester polymers such as styrene, vinyl 2-ethylhexanoate, vinyl caprate, vinyl laurate, vinyl pelargonate, vinyl hexanoate, vinyl propionate, vinyl decanoate, and vinyl octanoate. In one embodiment, a modifier may be present in an amount in the range of from about 0.1 weight percent to about 1 weight percent (based on the total weight of all the polymerizable polymers in the polymer mixture), from about 1 weight percent to about 20 weight percent, from about 20 weight percent to about 50 weight percent, or greater than about 50 weight percent.

A suitable modifier may include a liquid rubber. A suitable liquid rubber may have an average molecular weight of less than about 5,000, in a range of from about 5,000 to about 20,000, or greater than about 20,000. Incorporation of liquid rubbers in amounts of less than 5 weight percent, or in a range of from about 5 weight percent to about 10 weight percent, based on the overall weight of the adhesive formulation, may aid to form an adhesive which may be coextrudable with a base layer. A modulus of an adhesive may be relatively lowered by the incorporation of one or more liquid rubber. In one embodiment, incorporation of a liquid rubber into an adhesive may produce an adhesive having increased tack and/or adhesion, and may lower the glass transition temperature of the adhesive. Liquid block copolymers, such as liquid styrene-isoprene block copolymers may be used, for example, a liquid polyisoprene obtained by depolymerization of high molecular weight polyisoprene. An example of a commercially available depolymerized high molecular weight polyisoprene may be ISOLENE D-400 from Elementis Performance Polymers, (Belleville, N.J.). Other suitable liquid rubbers which may be incorporated into an adhesive may include one or more of liquid styrene-butadiene rubbers, liquid butadiene rubbers, ethylene-propylene rubbers, and the like.

A suitable curing agent may serve to crosslink a two-part adhesive. In one embodiment, a curing agent may be a multifunctional organic compound capable of reacting with functional groups located within the adhesive. Suitable curing agents may include amines, amides, phenols, thiols, carboxylic acids, carboxylic anhydrides, and mixtures thereof. In one embodiment, a curing agent may include polyoxyalkyleneamine. In one embodiment, a curing agent may include one or more anhydrides, such as cis-1,2-cyclohexane dicarboxylic anhydride, methyl hexohydropthalic anhydride, and mixtures thereof. A curing agent may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

A hardener may improve a curing reaction. Suitable hardeners may include amine hardeners, such as isophorone diamine, triethylene tetraamine, diethylene triamine, amino ethylpiperazine, 1,2- and 1,3-diaminopropane, 2,2-dimethyl propylenediamine, 1,4-diaminobutane, 1,6-diaminohexane, 1,7-diaminoheptane, 1,8-diaminooctane, 1,9-diaminononae, 1,12-diaminododecane, 4-azaheptamethylene diamine, N,N-bis(3-aminopropyl) butane-1,4-diamine, cyclohexane diamine, dicyandiamine, diamide diphenyl methane, diamide diphenyl sulfonic acid (amine adduct), 4,4-methylene dianiline, diethyltoluene diamine, m-phenylene diamine, melamine formaldehyde, tetraethylene pentamine, 3-diethylamino propylamine, 3,3-imino bis propylamine, 2,4-bis(p-aminobenzyl) aniline, tetraethylene pentamine, 3-diethylamino propylamine, 2,2,4- and 2,4,4-trimethylhexa methylene diamine, 1,2- and 1,3-diamino cyclohexane, 1,4-diamino-3,6-diethyl cyclohexane, 1,2-diamino-4-ethyl cyclohexane, 1,4-diamino-3,6-diethylcyclohexane, 1-cyclohexyl-3,4-dimino-cyclohexane, 4,4-diamino dicyclo hexylmethane, 4,4-diamino dicyclo hexylpropane, 2,2-bis(4-aminocyclohexyl) propane, 3,3-dimethyl-4,4-diamino dicyclohexyl methane, 3-amino-1-cyclohexane aminopropane, 1,3- and 1,4-bis(aminomethyl) cyclohexane, m- and p-xylylene diamine, and mixtures thereof. In one embodiment, an amine hardeners includes melamine formaldehyde. A hardening agent may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

Suitable flexibilizers may include one or more of silicone polymer additives, including fumed and unfumed silica; alumina polymer additives, including fumed and unfumed alumina; polysulfide rubbers; and mixtures of two or more thereof. Flexibilizers may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

Suitable catalysts may include substances that contain an unshared pair of electrons in an outer orbital, including Lewis Bases such as tertiary amines, imidazoles, and imidazolines. In one embodiment, a catalyst may include one or more of 2-ethyl-4-methyl-imidazole, N-(3-aminopropyl) imidazole, 2-phenyl-2-imidazoline, and mixtures of two or more thereof. A catalyst may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

In one embodiment, an adhesive may have a glass transition temperature (T_{g}) (measured by differential scanning calorimetry) in a range of less than about 0 degrees Celsius, less than about −10 degrees Celsius, or in a range of from about −30 degrees Celsius to about −10 degrees Celsius. In one embodiment, an adhesive may have a glass transition temperature in a range of from about 0 degrees Celsius to about 20 degrees Celsius, or in a range of from about 20 degrees Celsius to about 50 degrees Celsius, or higher.

In one embodiment, an adhesive may have an adhesion strength that is equal to or greater than the cohesive strength of the adhesive, a substrate to which the adhesive layer is secured, or both. Lap shear tests conducted using steel to steel one inch lap shears with both 0 mil gaps and 5 mil gaps for the bond-line, and pulled according to ASTM 700, which is incorporated by reference, at room temperature, at 50 degrees Celsius and at 100 degrees Celsius. Results are reported in pounds per square inch (PSI) required to break the lap shear.

In one embodiment, an adhesive may have lap shear test adhesive strengths at room temperature of less than 1000 PSI, in a range of from about 1000 PSI to about 1500 PSI, from about 1500 PSI to about 2000 PSI, from about 2000 PSI to about 2500 PSI, from about 2500 PSI to about 3000 PSI, or greater than about 3000 PSI. In one embodiment, an adhesive may have lap shear test adhesive strengths at about 50 degrees Celsius of less than 1000 PSI, in a range of from about 1000 PSI to about 1500 PSI, from about 1500 PSI to about 2000 PSI, from about 2000 PSI to about 2500 PSI, from about 2500 PSI to about 3000 PSI, or greater than about 3000 PSI. In one embodiment, an adhesive may have lap shear test adhesive strengths at about 100 degrees Celsius of less than 1000 PSI, in a range of from about 1000 PSI to about 1500 PSI, from about 1500 PSI to about 2000 PSI, from about 2000 PSI to about 2500 PSI, from about 2500 PSI to about 3000 PSI, or greater than about 3000 PSI.

A barrier layer according to embodiments of the invention may include a plurality of barrier structures that each may define a point, a sharp edge, a spike, a barb, a hook, and the like, combinations thereof, or a plurality of one or more thereof. In one embodiment, however, a barrier structure may be dull, rounded, or not sharp, particularly when hollow, as described further hereinbelow. Generally, each of a plurality of barrier structures may function to puncture, cut, tear, snag, and the like at one or more free ends.

Each of a plurality of barrier structures may secure to a base layer at one or more secured ends. Accordingly, in one embodiment a suitable barrier structure may define a cantilever, having a fixed end secured to a base layer, and a free end facing outward from the barrier article and ending in a sharp point. To reduce or eliminate the ability of defeating a barrier article having a cantilever barrier structure, a combination of differing barrier structures may be employed in combination. To prevent defeat by an overlaying of a barrier article with a heavy covering, for example, a puncture type barrier structure may be used; a caltrop type barrier structure may be used, a springing concertina type barrier structure may be used, active barrier structures (described further hereinbelow) may be used, and the like, and combinations thereof.

Barrier structure free ends may extend from a base layer surface by a length that may be less than about 0.5 centimeter, in a range of from about 0.5 centimeter to about 1 centimeters, from about 1 centimeters to about 2.5 centimeters, from about 2.5 centimeters to about 5 centimeters, from about 5 centimeters to about 7.5 centimeters, from about 7.5 centimeters to about 10 centimeters, or greater than about 10 centimeters. In one embodiment, barrier structures may have substantially the same length. In one embodiment, barrier structures of a plurality have differing lengths relative to each other.

A barrier structure may be substantially linear, may be curved, or may be angled along its length. In one embodiment, a barrier structure loops from a base layer back to the base layer, and may make one or more loops along its length. Suitable barrier structures may be oriented relative to a plane defined by a base layer to which they are secured. Suitable orientations may include 90 degrees, in a range of from about 90 degrees to about 80 degrees, from about 80 degrees to about 70 degrees, from about 70 degrees to about 55 degrees, from about 55 degrees to about 45 degrees, from about 45 degrees to about 25 degrees, or less than about 25 degrees. Further, barrier structures may be aligned relative to each other in substantially the same direction, or, alternatively, may be aligned randomly, or may be aligned so that a free end points toward a peripheral edge, or a center, of a barrier article.

In one embodiment, barrier structures may be arrayed randomly in the barrier layer. In one embodiment, barrier structures may be arrayed in a pattern in a barrier layer. Suitable patterns may include offset rows, substantially uniform rows, substantially uniformly arrayed clusters of barrier structures, and the like. In one embodiment, rows of clusters of barrier structures may be arranged on a surface of the base layer. If differing types of barrier structures are used, each type may be arranged in a pattern independent of each other type, or may be arranged with reference to one or more other type of barrier structure.

Barrier structures may be formed from materials that may include metal, polymers, glass, ceramic, cermet, natural materials such as stone and wood, and composite materials, and the like, and combinations of two or more of the foregoing. Suitable polymers, metals, glasses, ceramics, cermets, and the like may be substantially the same as those listed hereinabove as suitable for use in forming a base layer. In one embodiment, the barrier structure and the base layer may include substantially the same material. In one embodiment, the barrier structure and the base layer may include substantially different materials.

A metal barrier structure may be formed of spring steel, and may be configured as a caltrop, or as having one or more projections and a substantially wide base. In such an embodiment, a thermoplastic base layer may be used in combination with a dual adhesive type adhesive layer. The thermoplastic base layer may be a flexible, high-temperature polyolefin based polymer having a reinforcement of glass fiber weave. The adhesive layer may include a light duty pressure sensitive adhesive disposed in discontinuous amounts throughout a substantially continuous layer of moisture cured structural adhesive. During manufacture, extended sharp ends of the barrier structure may be forced through a molten base layer, and the glass fiber reinforcement so that the barrier layer base is on an opposite side of the base layer from the projection free ends. The barrier layer may be cooled, and may harden. The adhesive layer may be then applied over the base layer surface having the barrier layer base. Optionally, a release liner may be placed over the adhesive layer, over the barrier layer, or both.

In one embodiment, a base layer may have a layer of structural adhesive coated onto a side thereof, and a plurality of barrier structures adhered to the base layer using the adhesive coating following a curing step. A second adhesive layer may be applied to an opposite side of the base layer. Optionally, an additional device, such as a device described hereinbelow, may be embedded between, for example, the second layer and the base layer during manufacture. Optionally, a reinforcing layer such as a metal mesh, which may be initially distinct from the base layer, may be embedded in the adhesive layer during manufacture.

In one embodiment, a barrier structure may be formed from a frangible material, such as glass, ceramic, cermet, brittle metal, and the like, or combinations of two or more thereof. Naturally, frangible barrier structures may be included in barrier articles that may be disposable and/or replaceable after use. Such frangible barrier structures may, of course, be used in combination with more robust barrier structures, if desired. Frangible barrier structures may be uniformly distributed throughout a barrier layer, or may be randomly distributed throughout. In one embodiment, a frangible barrier structure may be disposed below a level of other non-frangible barrier structures, which may prevent unwanted access or tampering with the frangible barrier structures prior to their intended use.

Suitable frangible barrier structures may be hollow, and may be filled with one or more predetermined compositions. Such filled frangible barrier structures are referred to as ampoules, and such predetermined materials that may fill the ampoules are referred to as ampoule loads. In one embodiment, an ampoule may be pointed or sharp to facilitate puncturing, for example, clothing, skin, and/or protective gear. In one embodiment, an ampoule may be dull or rounded, and may be configured to break easily in response to tampering or pressure beyond that associated with installation or application.

As noted above, an ampoule may be loaded with one or more compositions. Amounts and concentrations of an ampoule load may be constrained by a volume of the interior of an ampoule, and desired effect of the ampoule load. In one embodiment, an ampoule load amount may be less than about 0.1 gram, in a range of from about 0.1 gram to about 0.5 grams, from about 0.5 grams to about 1 gram, or more than about 1 gram.

Suitable ampoule loads may include liquid, solids, waxy solids, powdered solids, gases, and combinations thereof. Suitable solids may include powders of crystallized liquids, and powdered carrier materials impregnated or including a liquid. Suitable liquids may include solutions, slurries, and the like of solid materials. Examples of suitable composition materials for use as ampoule loads are disclosed hereinbelow. Selection of composition materials may be made with reference to a desired effect of the material, the end use, use conditions, availability of materials, intended length of service, and the like, and combinations of two or more thereof.

Suitable ampoule load compositions may include one or more adhesive; incapacitating agent; lachrymator; vesicant; nerve agent; pulmonary agent; toxin; malodorant; derivative or analog of any of the foregoing; or the like, and combinations of two or more thereof. Alternatively, a plurality of ampoules may include, separately, precursors to the above load compositions, which, when ampoules are broken and the precursor contents are mixed may form an ampoule load composition as disclosed above. Additional compositions for the load may include one or more of a marking agent, an additive, or the like.

Suitable adhesives may include one or more of the adhesives described hereinabove with reference to the adhesive layer. In one embodiment, the adhesive may include a quick setting cyanoacrylate adhesive, such as commercially available methyl-2-cyanoacrylate or 2-octyl cyanoacrylate.

Suitable incapacitating agents may include nervous system affecters, vomiting agents, choking agents, hallucinogens, sedatives, narcotics, depressants, and the like, and combinations of two or more thereof. In one embodiment, an incapacitating agent may include 3-quinuclidinyl benzilate (QNB, BZ), which may be an anticholinergic agent that affects both the peripheral and central nervous systems (CNS). Alternative nervous system affecters may include commercially available over the counter (OTC) or prescription pharmaceutical compositions. In one embodiment, an incapacitating agent may include curare, or a curare analog or derivative.

Suitable lacrymators, or irritants, may include compositions that cause tearing and/or inflammation of the mucous membrane proximate to the eyes. In one embodiment, a lacrymator may include one or more of o-chlorobenzylmalonitrile, chloromethyl chloroformate, stannic chloride, sym-dichloromethyl ether, benzyl bromide, xylyl bromide, methyl chlorosulphonate, ethyl iodoacetate, bromacetone, bromomethyl-ethyl ketone, acrolein (2-propanal), capsaicin and derivatives, or the like.

A suitable vesicant or blister agent may cause blisters when contacted to skin. In addition to causing blisters, a vesicant may damage membranes. Tissues that may be vulnerable to vesicant action may include one or more of eyes and airways by topical contact, or the gastrointestinal tract and/or bone marrow after absorption. A suitable vesicant may include one or more of sulfur mustard, nitrogen mustard, or an arsenical, such as Lewisite, and combinations of two or more thereof. Suitable sulfur mustard may include one or more of 2-chloroethyl chloromethyl sulfide, bis(2-chloroethyl) sulfide or dichloroethyl disulfide, bis(2-chloroethylthio) methane, 1,2-bis(2-chloroethylthio) ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl) ether, bis(2-chloroethyl thioethyl) ether, combinations of two or more thereof. Suitable nitrogen mustard may include one or more of bis(2-chloroethyl) ethylamine, bis(2-chloroethyl) methylamine, or tris(2-chloroethyl) amine, or combinations of two or more thereof. Suitable Lewisites may include one or more of 2-chlorovinyldichloroarsine, bis(2-chlorovinyl) chloroarsine, tris(2-chlorovinyl) arsine, or combinations of two or more thereof.

A vesicant, once released from an ampoule and contacted to skin, may cross the skin or mucous membrane barrier. A vesicant may attach to cellular or tissue components where the vesicant later may cause damage. Effects from a suitable vesicant may appear in less than about 5 minutes, in a range of from about 5 minutes to 1 hour, from about 1 hour to about 2 hours, from about 2 hours to about 24 hours after contact.

Suitable nerve agents may include cholinesterase inhibitors. In one embodiment, a cholinesterase inhibitor may include one or more of o-alkyl (Me, Et, n-Pr or i-Pr)-phosphonofluoridates, such as o-isopropyl methylphosphonofluoridate (sarin) or o-pinacolyl methylphosphonofluoridate (soman); o-alkyl N,N-dialkyl (Me, Et, n-Pr or i-Pr) phosphoramidocyanidates, such as o-ethyl N,N-dimethyl phosphoramidocyanidate (tabun); or o-alkyl S-2-dialkyl (Me, Et, n-Pr or i-Pr)-aminoethyl alkyl (Me, Et, n-Pr or i-Pr) phosphonothiolates and corresponding alkylated or protonated salts, such as o-ethyl S-2-diisopropylaminoethyl methyl phosphonothiolate (VX); and combinations thereof.

Suitable pulmonary agents may include one or both of phosgene (carbonyl chloride) and perfluororoisobutylene. After inhalation, a pulmonary agent may breakdown the alveolar-capillary membrane, which may allow plasma to leak into the alveoli. Suitable toxins may include one or more of palytoxin, ricin, saxitoxin, or botulinum toxin, or combinations of two or more thereof.

Suitable blood agents may include forms of cyamide, such as salts, analogs and derivatives. A suitable solid salt of cyamide may include sodium, potassium, and/or calcium. A suitable volatile liquid form of cyamide may include hydrogen cyamide and/or cyanogen chloride. The addition of an acid, such as sulfuric acid, may be co-packaged in separate ampoules so that crushing a plurality of ampoules may release both cyamide and the acid. Cyamide may inhibit the cellular enzyme cytochrome oxidase to inhibit oxygen metabolism and energy generation by the cell. Most signs and symptoms are of central nervous system origin and after inhalation of a large amount include a brief period of hyperpnea, seizures, a decrease in breathing rate until apnea occurs, and at sufficiently large dosages cardiac arrhythmia. A slower absorption may lead to effects including vertigo, nausea, and a feeling of weakness.

In one embodiment, an ampoule load may include a malodorant composition. Suitable malodorant compositions may include a malodorant compound. A suitable malodorant composition may contact and stimulate the olfactory and/or trigeminal nerves of proximate persons to the release. An expected response may be characterized by a strong desire to avoid the substance and may be accompanied by immediate nausea and gagging. Persons exposed to the malodorant may be averse thereto and may wish to exit from an area in which a malodorant has been dispersed or released.

In one embodiment, a malodorant compound may include one or more sulfur-based compounds, nitrogen-based compounds, halogen-based compounds, both nitrogen- and sulfur-based compounds, or metal-based compounds. An organic component of a malodorant compound may include one or more linear, non-linear, aromatic, and/or cyclic arrangement of carbon atoms, and may contain saturated and/or unsaturated carbon bonding.

A suitable malodorant composition may include one or more indoles selected from 2-methyl indole, 3-methyl indole, 4-methyl indole, 5-methyl indole, 6-methyl indole, and 1-Butyl indole. Additional suitable odorants may include musk, hydrogen sulfide, aliphatic diamines such as putrescine (tetramethylene diamine) or cadaverine (pentamethylene diamine), dicrotyl sulfide, butyl mercaptan, and the like.

Suitable malodorant compounds may include mercaptans, thiols, sulfides, disulfides, sulfoxides, sulfones, sulfonic acids, sulfinic acids, thio-acids, dithio-acids, thiolo-acids, thiono-acids, sulfonyl halides, thiazoles, sulfur amines, sulfides, amides, organic derivatives, and the like, including mixtures of any two or more of the foregoing. Suitable non-limiting examples of such compounds include methyl mercaptans, ethyl mercaptans, propyl mercaptans, butyl mercaptans, amyl mercaptans, phenyl mercaptans, benzyl mercaptans, 2-mercaptoethanol, 1,2-ethanedithiol, 3-methyl-1-butanethiol, ethylcyclohexydithiol, d-limonene dimercaptan, vinyl cyclohexene-derived dimercaptan, perchloromethyl mercaptan, methyl sulfide, ethyl sulfide, propyl sulfide, isopropyl sulfide, ethyl methyl sulfide, dimethyl sulfide, dimethyl disulfide, diethyl sulfide, di-n-propyl disulfide, butyl disulfide, bibutyl sulfide, trimethylene sulfide, ethylene sulfide, propylene sulfide, allyl sulfide, mercaptoethyl sulfide, cyclopropyl phenyl sulfide, dimethyl trisulfide, dimethyl sulfoxide, propyl allyl sulfoxide, 3-chloropropyl n-octyl sulfoxide, allyl n-octyl sulfoxide, 2-methallyl n-octyl sulfoxide, methanesulfonic acid, methanesulfonyl chloride, ethanesulfonyl chloride, propanesulfonyl chloride, benzothiazole, 2-mercapto benzothiazole, N-isopropyl-2-benzothiazole sulfenamide, N,N-diisopropyl-2-benzothiazolesulfenamide, N-tert-butyl-2-benzthizole sulfenamide, N-cyclohexyl-2-benzothiazole sulfenamide, N,N-dicyclohexyl benzothiazole sulfenamide, and other like malodorous organic sulfur compounds, including mixtures of any two or more of the foregoing.

In one embodiment, suitable organic sulfur compounds may include aliphatic mercaptans, and analogs, derivative, and salts thereof. In one embodiment, the aliphatic component of the mercaptan includes from about 3 to about 12 carbon atoms per molecule. Examples of such compounds include methyl mercaptans, ethyl mercaptans, propyl mercaptans, isopropyl mercaptans, n-butyl mercaptans, isobutyl mercaptans, s-butyl mercaptans, t-butyl mercaptans, n-amyl mercaptans, s-amyl mercaptans, isoamyl mercaptans, t-amyl mercaptans, n-hexyl mercaptans, n-heptyl mercaptans, n-octyl mercaptans, s-octyl mercaptans, n-nonyl mercaptans, t-nonyl mercaptans, n-decyl mercaptans, undecyl mercaptans, n-dodecyl mercaptans, t-dodecyl mercaptans, triisobutyl mercaptans, and the like, including mixtures of any two or more of the foregoing.

The concentration of the malodorant composition in embodiments of the invention may differ depending on such factors as, for example, the particular malodorant compound employed, structural considerations of the barrier layer, other compositions present, and on the intended application for the malodorant composition and the article.

In one embodiment, the malodorant may include an organic sulfur compound present at a concentration in the range of from about 1 weight percent to about 100 weight percent, from about 1 weight percent to about 10 weight percent, from about 10 weight percent to about 50 weight percent, or from about 50 weight percent to about 75 weight percent. Here and throughout the specification and claims, the range limits may be combined and interchanged.

In addition to the malodorant compound, the malodorant composition may include one or more additives. Suitable additives may include one or more odor intensifier, diluent, oil, flow modifier, tackifier, thickener, heat stabilizer, preservative (e.g., EDTA), effervescent, foaming agent, wetting agent, anti-foaming agents, anti-static agents, or marking agent. In one embodiment, an odor intensifier may be skatole. Skatole is an indole and may be a component of fecal matter. The term “skatole” includes the compound 3-methylindole.

Suitable diluents may include aqueous solutions, organic solvents, and oils. Suitable organic solvents may include natural and synthetic esters, ethers, ketones, nitriles, hydrocarbons, and mixtures of any two or more of the foregoing.

Suitable oils may include natural oils and mineral oils. Suitable natural oils may include almond oil, castor oil, corn oil, cottonseed oil, hemp oil, linseed oil, olive oil, peanut oil, rapeseed oil, sesame oil, safflower oil, tung oil, and the like, and combinations of two or more thereof. Suitable mineral oils may include synthetic oils such as homo- and inter-polymers of C2-C12 olefins, carboxylic acid esters of both monoalcohols and polyols, polyethers, silicones, polyglycols, silicates, alkylated aromatics, carbonates, thiocarbonates, orthoformates, phosphates and phosphites, borates and halogenated hydrocarbons. Additional suitable synthetic oils may include the esters of dicarboxylic acids (e.g., phthalic acid, succinic acid, maleic acid, azelaic acid, suberic acid, sebacic acid, fumaric acid, adipic acid, linoleic acid dimer) with a variety of alcohols (e.g., butyl alcohol, hexyl alcohol, dodecyl alcohol, 2-ethylhexyl alcohol, and ethylene glycol). Suitable esters may include dibutyl adipate, di(2-ethylhexyl) adipic, didodecyl adipate, di(tridecyl) adipate, di(2-ethylhexyl) sebacate, dilauryl sebacate, di-n-hexyl fumarate, dioctyl sebacate, diisooctyl azelate, diisodecyl azelate, dioctyl phthalate, didecyl phthalate, di(eicosyl) sebacate, and 2-ethylhexyl diester of linoleic acid dimer.

Suitable silicon-based oils may include polyalkyl-, polyaryl-, polyalkoxy-, and polyaryloxy-siloxane oils and silicate oils, e.g., tetraethyl silicate, tetra isopropyl silicate, tetra(2-ethylhexyl) silicate, tetra(p-tert-butylphenyl) silicate, poly(methyl) siloxanes, and poly(methylphenyl) siloxanes). Other suitable synthetic oils may include liquid esters of phosphorus-containing acids (e.g., tricresyl phosphate, trioctyl phosphate, triphenyl phosphite, and diethyl ester of decane phosphonic acid.

In one embodiment, the ampoule load may include additional materials. These additional materials may include one or more of preservatives, such as ethylene diamine tetraacetic acid (EDTA), viscosity modifiers, foaming agents or anti-foaming agents, anti-static agents, effervescents, and the like, including mixtures of any two or more of the foregoing. An effervescent may cause an evolution of bubbles of gas from a liquid as a result of a chemical reaction.

A suitable ampoule load may include a marking agent. Suitable marking agents may include a non-washable, semi-permanent to permanent marker of clothes, uniforms, equipment and/or skin. In one embodiment, a marking agent includes dense pigmentation to allow for improved visibility. To increase contrast and visibility, the marking agent may be a bright color, such as yellow, orange, white, and the like. In one embodiment, a marking agent may be florescent, iridescent, and/or luminescent. In one embodiment, a marking agent may include a material that fluoresces in response to exposure to ultraviolet light. In one embodiment, the marking agent may include one or more materials that are not visible marking materials, but may be detectable by other means, such as magnetic particles, coded crystalline structures, miniature bar codes, pre-selected protein sequences, and the like.

In one embodiment, an ampoule may be pressurized, for example, with carbon dioxide or nitrogen gas. Alternatively, an ampoule may include a material that foams and/or effervesces in contact with air to create a propulsive force that may, for example, project or spread an ampoule load. In another embodiment, an ampoule may be rugged and resistant to fracture in a first direction, but fragile and easy to fracture in response to force applied in a second, different direction.

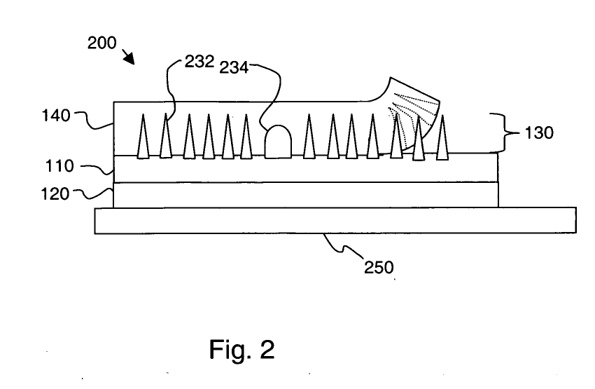

A barrier article 200 comprising an embodiment of the invention is shown in FIG. 2. The barrier article 200 may include a base layer 210, an adhesive layer 220 disposed on a first surface of the base layer 210, and a barrier layer 230 disposed on a second surface of the base layer 210, opposite the adhesive layer 220. The barrier layer 230 may include a barrier structure 232 that is one of a plurality of like barrier structures, or dissimilar barrier structures 234. Each barrier structure 232 may have a first portion proximate to the base layer 210, and a distal portion spaced from the base layer 210. A release liner 240 may be releasably secured to the barrier layer 230 and to the second surface of the base layer 210. The release liner 240 has a thickness that extends from the base layer second surface outward beyond the distal portion of the barrier structure 232.

In one embodiment, a release liner may include a non-compressible or a relatively low compressible material. Suitable release liners may be formed from, for example, closed cell foamed polymers. Suitable polymers may include those polymers listed as suitable for use in a base layer. In one embodiment, a release liner may be multi-layered, and one of the sub-layers may include, for example, a flexible metal layer or metallized polymer layer. Suitable expansion agents for use in forming foamed layers may include thermoplastic hollow spheres, such as EXPANCEL 551DU, which is commercially available from Expancel, Inc. (Duluth, Ga.). Other suitable expansion agents may include one or more of diazoaminobenzene; azobis (isobutyronitrile); dinitroso pentamethylene tetramine; N,N′-dinitroso-N,N′-dimethylterephthalamide; azodicarbonamide; sulfonyl hydrazides; benzene sulfonyl hydrazide; toluene sulfonyl hydrazide; oxybis(benzene sulfonyl hydrazide); sulfonyl carbazides; azodicarboxylic acid esters; or azodicarboxylic acid salts; and the like.

The release liner 140 may be formed in place on and around the barrier layer 130. Barrier structures 232, 234 of the barrier layer 130 may be therefore releasably encased in the release liner 140.

During use, the release liner 140 blocks access to the barrier layer 130, that is, pressure may be applied to an outer surface of the release liner 140 and the distal portion of a barrier structure 232 does not puncture either the release liner or, for example, a hand that is applying the pressure. Additionally, the frangible barrier structure 234 in the barrier layer 130 may be protected from breakage, particularly during manufacture, storage, transport, and installation by the release liner 140. The barrier article 200 may be adhesively secured to a surface of a substrate 250, such as concrete. One placed in adhesive contact with the substrate, the barrier article 200 may have the release liner 140 removed and/or discarded, as shown in FIG. 2 with a portion of the release liner 140 removed or peeled back. Removal of the release liner 140 exposes the barrier layer 130, which may provide a barrier function, or a deterrent function.

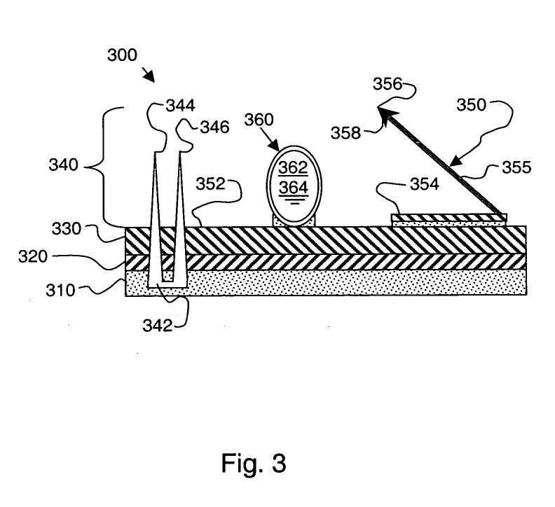

With reference to FIG. 3, a barrier article 300 according to embodiments of the invention is shown. The barrier article 300 may include a dual-adhesive type adhesive layer 310, a metal-mesh or fiber-mesh reinforcing layer 320, a reinforced polymeric base layer 330, and a barrier layer 340. As shown, a first barrier structure 342 may be formed of resilient metal and extends through the base layer 330 to pointed free ends 344, 346. A second barrier structure 350 may be formed of carbon-carbon composite and may be adhered to an exposed surface 352 of the base layer 330 by a secured portion 354, and may have a shaft 355 that may extend from the surface 352 at an angle of about 45 degrees to a sharp free end 356 having a barb structure 358 thereon. A third barrier structure 360 may be formed from frangible glass and may have an interior surface that defines a volume 362 of about 0.5 milliliters. A load 364 in the volume 362 may include an ampoule load, as described herein. In the embodiment illustrated in FIG. 3, the ampoule load may include a marking agent, an incapacitating agent, an effervescent, a foaming agent, a carrier liquid, and a malodorant. The marking agent may include a permanently-staining visual-fluorescent Day-Glo type dye. The malodorant may include a mercaptan. The incapacitating agent may include capsaicin. The carrier liquid may include a short chain alcohol. The foaming agent may include a surfactant. The effervescent may include, for example, sodium bicarbonate, citric acid and tartaric acid, wherein the acid and base may react to form bubbles of carbon dioxide, water and a salt.

Barrier articles comprising embodiments of the invention may be configured to have widths and lengths tailored, or tailorable, to particular applications or end uses. Suitable widths may be less than 1 centimeter, in a range of from about 1 centimeter to about 25 centimeters, from about 25 centimeters to about 75 centimeters, from about 75 centimeters to about 150 centimeters, from about 150 centimeters to about 250 centimeters, from about 250 centimeters to about 500 centimeters, from about 500 centimeters to about 1 meter, from about 1 meter to about 2.5 meters, or greater than about 2.5 meters. Suitable lengths may be less than 25 centimeters, in a range of from about 25 centimeter to about 75 centimeters, from about 75 centimeters to about 175 centimeters, from about 175 centimeters to about 350 centimeters, from about 350 centimeters to about 500 centimeters, from about 500 centimeters to about 1 meter, from about 1 meter to about 5 meters, from about 5 meters to about 10 meters, from about 10 meters to about 25 meters, or greater than about 25 meters. In one embodiment, a barrier article is a relatively long and narrow tape, which optionally may be in a roll prior to use. In one embodiment, a barrier article may be configured as squares that are about 300 centimeters to a side, and which may be used side-by-side to cover an area of a substrate.

In one embodiment, strips of a barrier article may be sized and shaped to wrap around poles, such as light poles, telephone poles, gutters, and the like. Other shapes may also be suitable, such shapes may include irregular or customized shapes, circles and ovals, triangles, zig-zags, sinusoids, rings, and/or polygons. In one embodiment, a barrier article may be configure so that rather than the thickness laying in a plane, the barrier article defines a loop has a barrier layer facing inwards toward an axis, and an adhesive layer facing outwards away from the axis. In such an embodiment, an interior of, for example, a window well may be lined with the barrier article. Alternatively, the barrier layer may face away from the axis, and the adhesive layer may face toward the axis. In such an embodiment, an exterior of, for example, a drum may be wrapped with a barrier article.

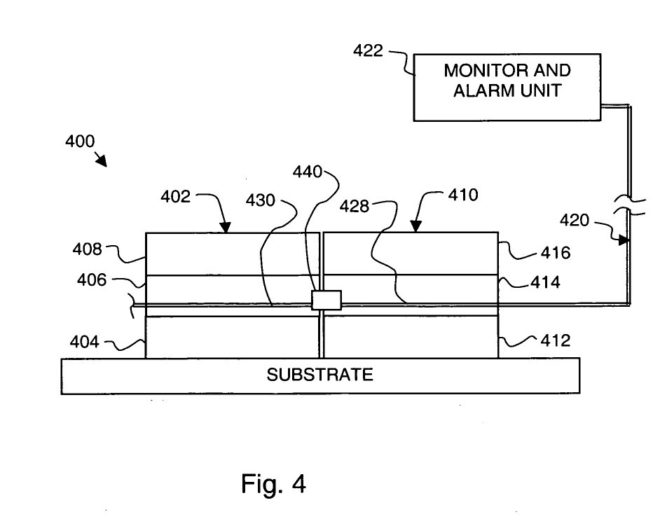

With reference to FIG. 4, a multi-component barrier article 400 comprising an embodiment of the invention is shown. The barrier article 400 may include a first component 402, which may have a first adhesive layer 404, a first base layer 406, and a first barrier layer 408; and a second component 410, which may have a second adhesive layer 412, a second base layer 414, and a second barrier layer 416. A conductive element system 420 communicates with a monitor and alarm unit 422. The conductive element system 420 may include a first conductive fiber 428 embedded in the matrix of the first component base layer 404, and a second conductive fiber 430 embedded in the matrix of the second component base layer 414. A connector 440 communicates the first conductive fiber 428 with the second conductive fiber 430.

In one embodiment, a conductive element has a length that extends beyond a peripheral edge of a barrier article component to a connector. During installation, the connector can be connected to another connector to extend the conductive element, and excess length may be tucked under, and sealed under, the adhesive layer as the adhesive layer is secured to a substrate. In one embodiment, a conductive element may extend along a peripheral edge of a barrier article, or may cross back and forth along a length of the barrier article. Other arrangements of a conductive element may be selected with reference to an end use or application.

During use, tampering with the barrier article 400 may cause the monitor and alarm system 422 to detect the tampering via the conductive fibers 428, 430 and respond in a predetermined manner to report the tampering event.

Additional devices may be included in embodiments according to the invention, and may communicate directly or indirectly with receivers and/or monitors. Suitable devices may include one or more conductive elements, such as conductive fibers and conductive sheets. Suitable conductive elements may function as one or more of vibration sensors, continuity sensors, radio frequency identification devices (RFID), tamper sensors, flexion sensors, temperature sensors, and the like, and connectors for the foregoing. Strips of a barrier article may be applied to a substrate surface, and one or more of the conductive elements embedded therein may be connected from strip to strip using a connector to form a continuous length of conductive elements. Such a continuous length of conductive elements may be linear, may form a complete circuit, or may be in a web or net-like arrangement.

Conductive elements may include structures that extends throughout a base layer, an adhesive layer, and/or a barrier layer, and which conduct energy of a predetermined type. In one embodiment, the energy may be light from, for example, a light emitting diode (LED) or may be coherent light energy from a laser source. In one embodiment, the light energy can have a wavelength of less than about 850 nanometers (nm), in a range of from about 850 nm to about 1550 nm, or greater than about 1550 nm. Commercially available LED light sources may generate light having a wavelength closer to about 850 nm, while commercially available laser light sources typically generate light with a frequency closer to about 1550 nm. But, vertical cavity surface emitting lasers (VCSEL) typically generate light with a frequency closer to about 850 nm and also may be suited for use in the present embodiment.

In other embodiments, the energy may be electrical, heat, magnetic, other energy along the electromagnetic spectrum, or the like. The type of energy conducted can constrain the type of materials useful for forming the pathway. For example, energy may be light and the pathway may be an optical fiber or a bundle of like or dissimilar optical fibers. Suitable fibers may include glass fibers, such as those commercially available from Corning Cable Systems LLC (Hickory, N.C.). In one embodiment, optical fiber bundles may include polymeric fibers, or may be a combination of glass fibers and polymeric fibers. Suitable polymeric fibers include those with a methyl methacrylate core with fluorinated polymer cladding such as RAYTELA brand fibers, which are commercially available from Toray Industries (America), Inc.

In one embodiment, an optical fiber or optical fiber bundle may define a ridged cable. That is, an exterior surface of a fiber optic cable may have ridges to facilitate gripping in an embedded layer or a receiving structure. The embedded layer or a receiving structure may be single use or reusable. For reusable applications, the embedded layer or a receiving structure may define an elongate aperture through which subsequent replacement fiber optic bundles or cables may be inserted. Thus, for ridged cable embodiments, ridges may engage an inner surface that defines the elongate aperture and mechanically secure the cable in place. In one embodiment, the ridges may be angled and allow movement of the cable relative to the aperture-defining inner surface in one direction only. In one embodiment, the optical fibers have attachments on an end of each fiber, or on the end of the cable if bundled. The attachments may prevent a fiber or cable from being re-inserted into the embedded layer or a receiving structure once the fiber or cable has been removed from the embedded layer or a receiving structure.

As a further illustration of a suitable alternative conductive element in accordance with embodiments of the invention, a conductive element may be electrically conductive, or semi-conductive if the energy is electrical energy. In one embodiment, a conductive element may be a printed layer of electrically conductive ink, a layer of electrically conductive polymer, a layer of polymer doped or filled with electrically conductive filler material (e.g., nickel flake, carbon powder, or metallic fibers), a metal foil, or the like, supported on a surface of a base layer. Suitable electrically conductive inks may be commercially available from DuPont Electronic Materials, Inc. (Wilmington, Del.). An electrically conductive pathway comprising metal may be produced by, for example, chemical vapor deposition (CVD), sputtering coating, and/or printing with the metallic ink. Suitable metals for use in an electrically conductive pathway may include one or more of include titanium, silver, gold, aluminum, copper, iron, and alloys of these metals.

With reference to the monitor and alarm unit, in one embodiment a monitor and alarm unit may communicate directly to conductive element, but in another embodiment, the monitor and alarm unit may communicate with a signaling device, such as an RFID device, which is in direct communication with a conductive element. Accordingly, tampering with a conductive element (by exerting, for example, pressure, temperature, vibration, flexion, and the like, or by breaking continuity) may result in a signal being generated and sent to a monitor and alarm unit, either directly, or indirectly via, for example, a wireless device. Alternatively, in one embodiment, a conductive element may be passive, and may respond to a query by a monitor and alarm unit by not generating a signal, from which a monitor and alarm unit may infer tampering has occurred.

In one embodiment, a monitor and alarm unit may include a receiver for a signal generated by a radio frequency identification device (RFID) embedded in a base layer, adhesive layer, or barrier layer. In one embodiment, the RFID may be capable of interacting passively, and in other embodiments the RFID may be actively interactive with an RFID sensor located remote from the RFID, which may be in communication with the monitor and alarm unit. In addition, the RFID may include one or many optional components. Such optional components include an antenna, a memory chip, a power source, a receiver, a transmitter, a transponder, a light-to-electricity converter, integrated circuit. In one embodiment, other commercially available wireless communication devices may be used to communicate with an associated sensor, either actively or passively. Such alternative wireless communication devices include Bluetooth enabled devices, as well as other devices that utilize non-radio frequency electro-magnetic energy.

With reference to an antenna, various configurations may be possible for the antenna. In one embodiment, an antenna may include a plurality of distinct, separate antennas. One antenna may be provided for receiver functions and another antenna may be provided for transmitter functions. In one embodiment, a single antenna may be shared and functions as both the receiver and transmitter, or transponder. In one embodiment, an antenna may be defined by a conductive epoxy structure screen printed or flexographically printed onto a flexible insert. An antenna may be conductively bonded to the RFID via bonding pads. In an embodiment where a single antenna may be employed, that single antenna can include a folded dipole antenna defining a continuous conductive path, or loop, of microstrip. Alternatively, an antenna can be constructed as a continuous loop antenna.

For RFIDs that actively interact, they may include a power source. In one embodiment, the power source may be a battery. If the power source is a battery, the battery may take any suitable form. Factors that can be considered in pre-selecting the battery type include the weight, size, flexibility, power output, and life requirements for a particular application. In one embodiment, a battery may be a thin profile button-type cell forming a small, thin energy cell commonly utilized in watches and small electronic devices requiring a thin profile. A conventional button-type cell has a pair of electrodes, an anode formed by one face and a cathode formed by an opposite face. In one embodiment, the battery includes, in series, connected pairs of button type cells. In one embodiment, the battery is a flexible polymeric battery.

In one embodiment, the RFID transmits and receives radio frequency communications to and from a sensor communicating with the RFID. The RFID sensor can include an antenna and dedicated transmitting and receiving circuitry, similar to that implemented on the RFID. One example of an RFID sensor implemented in combination with a transponder unit may be disclosed in U.S. Pat. No. 4,857,893, which is hereby incorporated by reference to the extent it discloses RFID sensors. The RFID can include one or more receivers. If more than one receiver is used, one can be a low power receiver for detecting a wake up signal from an RFID sensor, and another can be a high power receiver for receiving commands from an RFID sensor. The antenna may be constructed and arranged to form a folded dipole antenna that may be the dual-function continuous conductive element or a loop. Terminal ends of the antenna form conductive leads that electrically interconnect with the RFID.

In one embodiment, a monitor and alarm unit may be a flip chip having a memory and may be electrically connectable using commercially available chip attachment methods. For example, the monitor and alarm unit may be electrically attached using a conductive adhesive, such as a polymeric conductive adhesive or an anisotropic conductive adhesive, which may be dispensed using, for example, a needle and syringe.

In one embodiment, a graphic layer may be overlayed onto a base layer such that an image or text may be visible through a barrier layer. Such a graphic layer image may include, for example, a warning statement. Suitable graphic layers may be formed via printing, coextrusion, and the like. In one embodiment, a graphic layer may be applied to a base layer during formation of the base layer, and prior to adding a barrier layer. In one embodiment, a graphic layer may include a dry paint layer that may be applied in liquid form to an otherwise complete barrier article, particularly prior to the addition of a release liner over a barrier layer. In one embodiment, a graphic layer may include luminescent ink, or fluorescent ink, or both.

The processes and embodiments described herein may be examples of structures, systems, compositions, and methods having elements corresponding to the elements of the invention recited in the claims. This written description may enable those of ordinary skill in the art to make and use embodiments having alternative elements that likewise correspond to the elements of the invention recited in the claims. The intended scope of the claimed invention thus includes other structures, systems, compositions, and methods that do not differ from the literal language of the claims, and further includes other structures, systems, compositions, and methods with insubstantial differences from the literal language of the claims.

What is claimed is:

1. A barrier article, comprising:
a base layer;
an adhesive layer supported on a first surface of the support layer; and
a barrier layer supported on a second surface of the support layer, opposite the adhesive layer.

2. The article as defined in claim 1, wherein the base layer comprises one or more of polymer, metal, ceramic, or glass.

3. The article as defined in claim 2, wherein the polymer comprises one or more of polyacrylamide, polyacrylate, polyamide, polycarbonate, epoxy, polyester, polyether, ionomer, polyimide, polyolefin, polystyrene, polyurethane, polyvinyl, silicone, polysiloxane, or norbornene polymer.

4. The article as defined in claim 1, wherein the base layer comprises reinforcement comprising one or more of metal, glass or polymer.

5. The article as defined in claim 1, wherein the adhesive layer comprises one or more of a pressure sensitive adhesive, a structural adhesive, a hot melt adhesive, or a curable adhesive.

6. The article as defined in claim 5, wherein the adhesive layer comprises one or more of acrylate, amide, acrylonitrile, carbonate, cyanate ester, cyanurate, ethylene-vinyl acetate, epoxy, fluoroplastic, ionomer, methyl methacrylate, non-ethylenic olefin polymer (linear or branched), nylon, olefin, polyester, styrene, styrene-maleic anhydride, sulfone, styrene-acrylonitrile, or urethane.

7. The article as defined in claim 1, wherein the adhesive layer comprises reinforcement.

8. The article as defined in claim 1, wherein the barrier layer comprises one or more of polymer, metal, ceramic, or glass.

9. The article as defined in claim 1, wherein the barrier layer comprises a barrier structure that is configured to cut or puncture contacting skin, cloth, or both.

10. The article as defined in claim 1, wherein the barrier layer comprises a barrier structure that is configured as a pin, a needle, a blade, a hook, a barb, or a combination of two or more thereof.

11. The article as defined in claim 1, wherein the barrier layer comprises a frangible barrier structure having an inner surface that defines a volume, and the volume is filled with an ampoule load.

12. The article as defined in claim 11, wherein the ampoule load comprises one or more of an adhesive; incapacitating agent; lacrymator; vesicant; nerve agent; pulmonary agent; toxin; malodorant; a derivative, precursor, or analog of any of the foregoing; visual marking agent; or, non-visual marking agent.

13. The article as defined in claim 12, wherein the malodorant comprises one or more of 2-methyl indole, 3-methyl indole, 4-methyl indole, 5-methyl indole, 6-methyl indole, and 1-butyl indole, musk, hydrogen sulfide, aliphatic diamines, tetramethylene diamine, pentamethylene diamine, dicrotyl sulfide, butyl mercaptan, methyl mercaptan, ethyl mercaptan, propyl mercaptan, amyl mercaptan, phenyl mercaptan, benzyl mercaptan, 2-mercaptoethanol, 1,2-ethanedithiol, 3-methyl-1-butanethiol, ethylcyclohexyldithiol, d-limonene dimercaptan, vinyl cyclohexene-derived dimercaptan, perchloromethyl mercaptan, methyl sulfide, ethyl sulfide, propyl sulfide, isopropyl sulfide, ethyl methyl sulfide, dimethyl sulfide, dimethyl disulfide, diethyl sulfide, di-n-propyl disulfide, butyl disulfide, bibutyl sulfide, trimethylene sulfide, ethylene sulfide, propylene sulfide, allyl sulfide, mercaptoethyl sulfide, cyclopropyl phenyl sulfide, dimethyl trisulfide, dimethyl sulfoxide, propyl allyl sulfoxide, 3-chloropropyl n-octyl sulfoxide, allyl n-octyl sulfoxide, 2-methallyl n-octyl sulfoxide, methanesulfonic acid, methanesulfonyl chloride, ethanesulfonyl chloride, propanesulfonyl chloride, benzothiazole, 2-mercapto benzothiazole, N-isopropyl-2-benzothiazole sulfenamide, N,N-diisopropyl-2-benzothiazolesulfenamide, N-tert-butyl-2-benzthizole sulfenamide, N-cyclohexyl-2-benzothiazole, sulfenamide, or N,N-dicyclohexyl benzothiazole sulfenamide.

14. The article as defined in claim 12, wherein the malodorant comprises one or more of mercaptan, thiol, sulfide, disulfide, sulfoxide, sulfone, sulfonic acid, sulfinic acid, thio-acid, dithio-acid, thiolo-acid, thiono-acid, sulfonyl halide, thiazole, sulfur amine, sulfide, amide, or organic derivatives of the foregoing.

15. The article as defined in claim 12, wherein the ampoule load comprises one or more of a preservative, viscosity modifier, foaming agent, anti-foaming agent, anti-static agent; effervescent, or a pressurized gas.

16. The article as defined in claim 12, wherein the non-visual marking agent comprises one or more of magnetic particles, laser etched particles, holographic crystals.

17. The article as defined in claim 1, further comprising an RFID supported by or embedded in, or supported by, one or both of the support layer or the adhesive layer.

18. The article as defined in claim 1, further comprising a conductive element supported by or embedded in one or more of the support layer, the adhesive layer, or the barrier layer.

19. The article as defined in claim 1, further comprising a release liner that is releasably secured to a surface of the adhesive layer opposite the base layer.

20. A barrier article, comprising:
means for adhering the barrier article to a substrate; and
means for discouraging a person to contact with an exposed surface of the barrier article.

21. A method, comprising:
securing a plurality of barrier structures to a base layer, each of the barrier structures having an extended end spaced from the base layer; and
securing an adhesive layer to a surface of the base layer opposite the extended end of the barrier structures.
